(19) United States
(12) Patent Application Publication
(10) Pub. No.: US 2012/0307641 A1
(43) Pub. Date: Dec. 6, 2012

(54) Dynamic Flow Segregation for Optimal Load Balancing Among Ports in an Etherchannel Group

(75) Inventors: Subbarao Arumilli, Santa Clara, CA (US); Prakash Appanna, Dublin, CA (US); Srihari Shoroff, Fremont, CA (US)

(73) Assignee: CISCO TECHNOLOGY, INC., San Jose, CA (US)

(21) Appl. No.: 13/118,664

(22) Filed: May 31, 2011

(51) Int. Cl. H04L 12/26; H04L 12/56

(52) U.S. Cl. 370/241

(57) ABSTRACT

Dynamic load balancing techniques among ports of a network device are provided. At a device configured to forward packets in a network, a plurality of queues are generated, each associated with a corresponding one of a plurality of output ports of the device and from which packets are to be output from the device into the network. When the number of packets in the at least one queue exceeds a threshold, for new packets that are to be enqueued to the at least one queue, packets are enqueued to a plurality of sub-queues such that packets are assigned to different ones of the plurality of sub-queues. Each of the plurality of sub-queues is associated with a corresponding one of the plurality of output ports. Packets of the plurality of sub-queues are output from corresponding ones of the plurality of output ports.

### TECHNICAL FIELD

The present disclosure relates to load balancing in a network switch device.

### BACKGROUND

An EtherChannel is a logical bundling of two or more physical ports between two switches to achieve higher data transmission. The assignment of an output port within an EtherChannel group is usually done at the time the frame enters the switch using a combination of hashing schemes and lookup tables, which are inherently static in nature. Moreover, conventional port mapping does not take into account the individual output port utilization, i.e., queue level. This can result in poor frame forwarding decisions to the output ports within an EtherChannel group, leading to underutilization of some ports and dropping of frames due to congestion in other output ports.

### BRIEF DESCRIPTION OF THE DRAWINGS

FIG. 1 is an example network diagram in which at least one of two switches is configured to perform dynamic load balancing among ports in an EtherChannel group.

FIG. 2 is a block diagram of an example switch, router or other similar device that is configured to perform dynamic load balancing among ports in an EtherChannel group.

FIG. 3 is a diagram illustrating an example of a queue link list and sub-queue link list stored in the device shown in FIG. 2.

FIGS. 4 and 5 are diagrams depicting operations associated with a sub-queuing load balancing scheme.

FIGS. 6 and 7 are flowcharts depicting example operations of the sub-queuing load balancing scheme.

FIG. 8 illustrates an example of an overutilized output port.

FIGS. 9 and 10 illustrate an example of the sub-queuing scheme used to load balance and reduce the utilization of an output port as depicted in FIG. 8.

FIG. 11 is a block diagram of an example switch, router or other device configured to perform the dynamic load balancing techniques described herein.

### DESCRIPTION OF EXAMPLE EMBODIMENTS

Overview

Dynamic load balancing techniques among ports of a network device are provided. At a device configured to forward packets in a network, a plurality of queues are generated, each associated with a corresponding one of a plurality of output ports of the device and from which packets are to be output from the device into the network. It is detected when a number of packets or bytes in at least one queue exceeds a threshold. When the number of packets in the at least one queue exceeds the threshold for new packets that are to be enqueued to the at least one queue, packets are enqueued to a plurality of sub-queues such that packets are assigned to different ones of the plurality of sub-queues. Each of the plurality of sub-queues is associated with a corresponding one of the plurality of output ports. Packets of the plurality of sub-queues are output from corresponding ones of the plurality of output ports.

### Example Embodiments

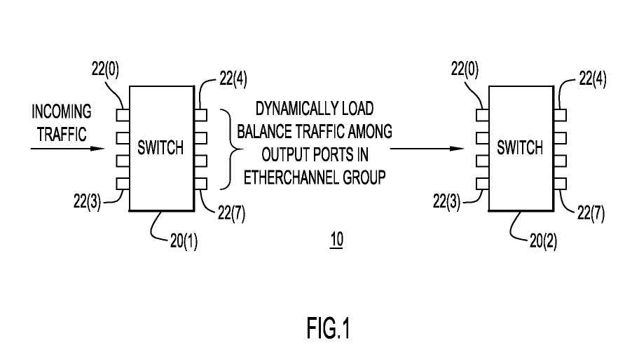

Referring first to FIG. 1, a network is shown at reference numeral 10 comprising first and second packet (frame) processing switches or routers (simply referred to herein as switches) 20(1) and 20(2). In the example network topology shown in FIG. 1, switch 20(1) has a plurality of ports, e.g., eight ports, 22(0)-22(7), as does switch 20(2). Switches 20(1) and 20(2) are shown to have eight ports, but this is only an example as they have any number of two or more ports. Also in this example, ports 22(0)-22(3) are input ports and ports 22(4)-22(7) are output ports on switches 20(1) and 20(2).

The switches 20(1) and 20(2) are configured to implement EtherChannel techniques. EtherChannel is a port link aggregation technology or port-channel architecture that allows grouping of several physical Ethernet links to create one logical Ethernet link for the purpose of providing fault-tolerance and high-speed links between switches, routers and servers. An EtherChannel can be created from between two and eight Ethernet ports, with an additional one to eight inactive (failover) ports which become active as the other active ports fail.

At least one of the switches, e.g., switch 20(1), is configured to dynamically allow for the segregation of outgoing flows to optimally load balance traffic among the output ports within an EtherChannel group and, as a result, maximize individual link utilization while guaranteeing in order packet delivery. These techniques can target problem output ports that are, for example, experiencing congestion. These techniques can be invoked when one or more physical ports in an EtherChannel group are overutilized, i.e., congested. Overutilization of a port indicates that other ports in the same EtherChannel group are underutilized. In some implementations, these techniques are only invoked when one or more physical ports are overutilized.

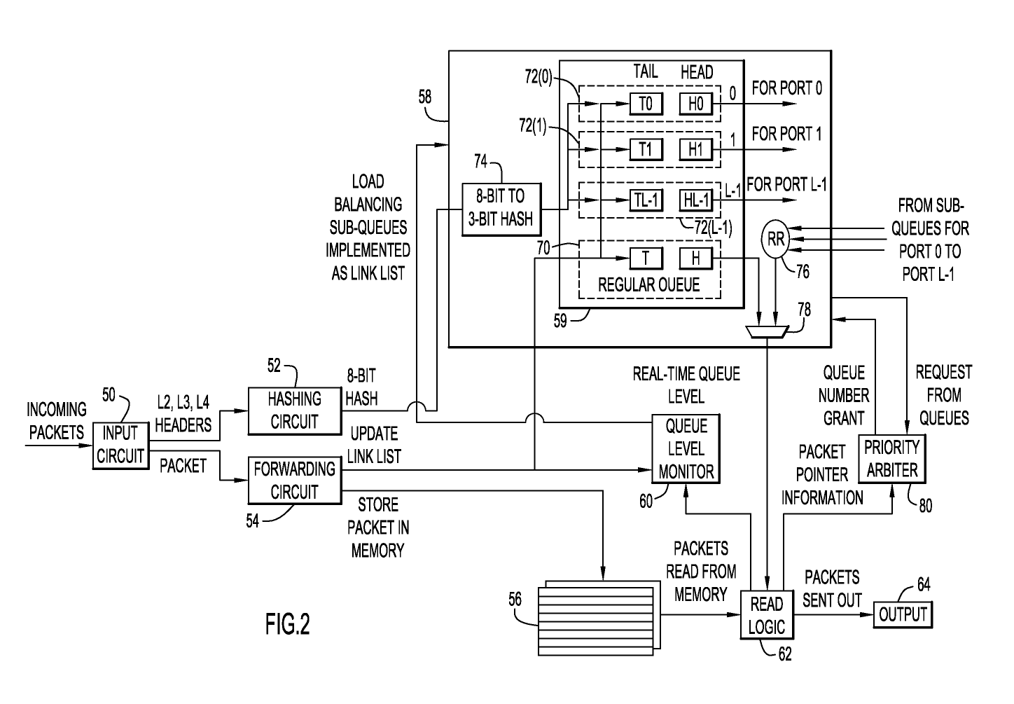

Reference is now made to FIG. 2 for a description of a block diagram of a switch, e.g., switch 20(1), that is configured to perform the dynamic load balancing techniques. This block diagram is also applicable to a router or other device that forwards packets in a network. The switch comprises an input circuit 50, a hashing circuit 52, a forwarding circuit 54, a collection of memory arrays 56 to store incoming packets to be forwarded, a queuing subsystem 58 that stores a queue list for a plurality of queues and a plurality of sub-queues, a queue level monitor circuit 60, a read logic circuit 62 and an output circuit 64. The memory arrays 56 serve as a means for storing packets that are to be forwarded in the network by the switch. The input circuit 50 receives incoming packets to the switch, and the forwarding circuit 54 directs the incoming packets into queuing subsystem 58. The forwarding circuit 54 also updates a link list memory in the queuing subsystem 58 to indicate the writing of new packets in memory 56. The hashing circuit 52 makes a hashing computation on parameters of packets, e.g., headers, such as any one or more of the Layer-2, Layer-3 and Layer-4 headers, in order to identify the flow that each packet is part of and the destination of the packet. In one example, the hashing circuit 52 computes an 8-bit hash on the headers and in so doing determines the queue for the associated port to which the packet should be added in the link list memory 59. The forwarding circuit 54 implements lookup tables. Using fields or subfields (from the Layer-2, Layer-3, and Layer-4 headers) from the header of the packet, the forwarding circuit 54 performs a look up in one or more destination tables to determine the EtherChannel Group Identifier (ID). Using the results of the hashing circuit 52, the forwarding circuit 54 determines the actual destination port where the packet is to be delivered or whether it is to be dropped.

The queuing subsystem 58 comprises a memory 59 that is referred to herein as the link list memory. In one form, the memory 59 is implemented by a plurality of registers, but it may be implemented by allocated memory locations in the memory arrays 56, by a dedicated memory device, etc. In general, the memory 59 serves as a means for storing a queue link list defining the plurality of queues of packets stored in the memory arrays 56 and for storing a sub-queue link list defining the plurality of sub-queues.

The link list memory 59 comprises memory locations (e.g., registers) allocated for at least one queue 70 (herein also referred to as a “regular” queue) and a plurality of sub-queues 72(0)-72(L−1). The regular queue stores an identifier for each packet stored in memory 56 that is part of the regular queue in order from head (H) to tail (T) of the queue. Likewise, each sub-queue stores an identifier for each packet stored in memory 56 that is part of a sub-queue also in order from H to T for each sub-queue. Each of the sub-queues 72(0)-72(L−1) is associated with a corresponding one of a plurality of physical output ports, designated as Port 0 to Port L−1. These ports correspond to the ports 22(4)-22(7), for example, shown in FIG. 1. In general, there are L sub-queues where L is equal to the number of physical output ports in an EtherChannel under consideration. The sub-queues 72(0)-72(L−1) are referred to as Load Balancing (LB) sub-queues because they are used to load balance the use of output ports based on their utilization.

The queuing subsystem 58 also comprises an 8-bit to 3-bit hashing circuit 74, a round robin (RR) arbiter 76 and an adder or sum circuit 78. The 8-bit to 3-bit hashing circuit 74 is configured to compute a 3-bit hash computation on packet headers to determine which of a plurality of sub-queues to assign a packet when it is determined to use sub-queues, as will become more apparent hereinafter. The 8-bit to 3-bit hashing circuit 74 is provided because the 8-bit hashing circuit 52 is a common component in switches and rather than re-design the switch to provide a lesser degree of hashing for enqueuing packets to the plurality of sub-queues, the additional hashing circuit 74 is provided. The hashing circuit 52 serves as a means for adding entries to a queue link list for at least one queue as new packets are added to the at least one queue. Moreover, the hashing circuit 52 in combination with the hashing circuit 74 serves as a means for adding entries to the sub-queue link list for the plurality of sub-queues such that packets are assigned to different ones of the plurality of sub-queues when congestion is detected on at least one port that is part of an EtherChannel group.

The RR arbiter 76 selects a packet from one of the plurality of same COS sub-queues from ports of the same EtherChannel group and directs it to the adder 78. The RR arbiter 76 comprises a digital logic circuit, for example, that is configured to select a packet from one of same COS sub-queues from ports of the same EtherChannel according to any of a variety of round robin selection techniques. The other input to the adder 78 is an output from the regular queue 70.

The queue level monitor 60 is a circuit that compares the current number of packets in the regular queue and in the sub-queues with a predetermined threshold. In another form, the queue level monitor 60 determines the total number of bytes in a queue or sub-queue. Thus, it should be understood that references made herein to the queue level monitor circuit comparing numbers of packets with a threshold may involve comparing numbers of bytes with a threshold. In one example, the queue level monitor 60 comprises a counter and a comparator that is configured to keep track of the amount of data (in bytes) stored in memory 56 for each queue. There can be a dedicated queue level monitor 60 for each regular queue. Thus, since only one regular queue is shown in FIG. 2, only one queue level monitor 60 is shown, but this is only an example. At the time packets are buffered in the memory 56, the counter of the queue level monitor (for that destination port and queue for which the packet is scheduled to go out) is incremented by the number of bytes in the packet. When a packet is read out of the memory 56 and sent out by the read logic circuit 62, the counter in the queue level monitor 60 for that queue is decremented by the number of bytes in the packet that is sent out. The queue level monitor 60 thus serves as a means for detecting when at least one queue exceeds a threshold indicative of a congested port, as well as when the at least one queue hits another predetermined threshold, e.g., 0, indicating that it is empty.

The read logic circuit 62 is configured to read packets from the memory 56 to be transmitted from the switch via the output 64. The order that the read logic circuit 62 follows to read packets from the memory 56 is based on the identifiers supplied from the link list memory 59 in the regular queue or plurality of sub-queues as described further hereinafter.

The read logic circuit 62 and output circuit 64 serve as a means for outputting packets from the memory 56. As will become apparent hereinafter, the read logic circuit 62 and output circuit 64 serve as a means for outputting packets from the memory 56 for the plurality of sub-queues according to the sub-queue link list in memory 59 after all packets in the queue link list in memory 59 for at least one queue have been output from the memory 56.

The hashing circuit 52 serves as a means for adding entries to a queue link list for at least one queue as new packets are added to the at least one queue. Moreover, the hashing circuit 52 in combination with the hashing circuit 74 serves as a means for adding entries to the sub-queue link list for the plurality of sub-queues such that packets are assigned to different ones of the plurality of sub-queues when at least one queue exceeds the aforementioned threshold indicative of a congested port.

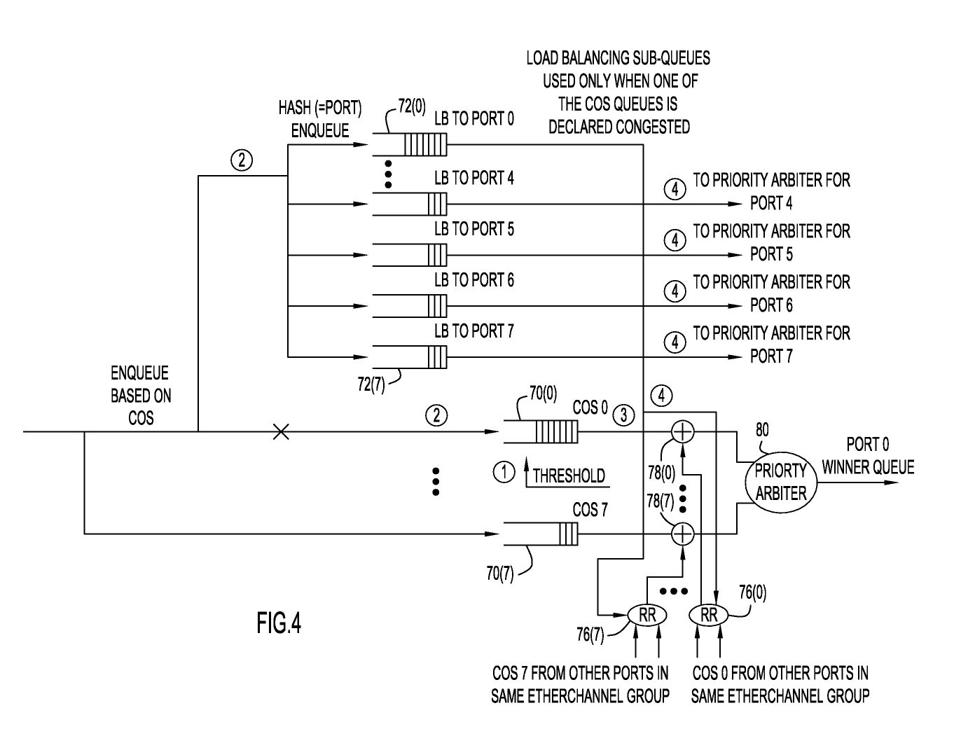

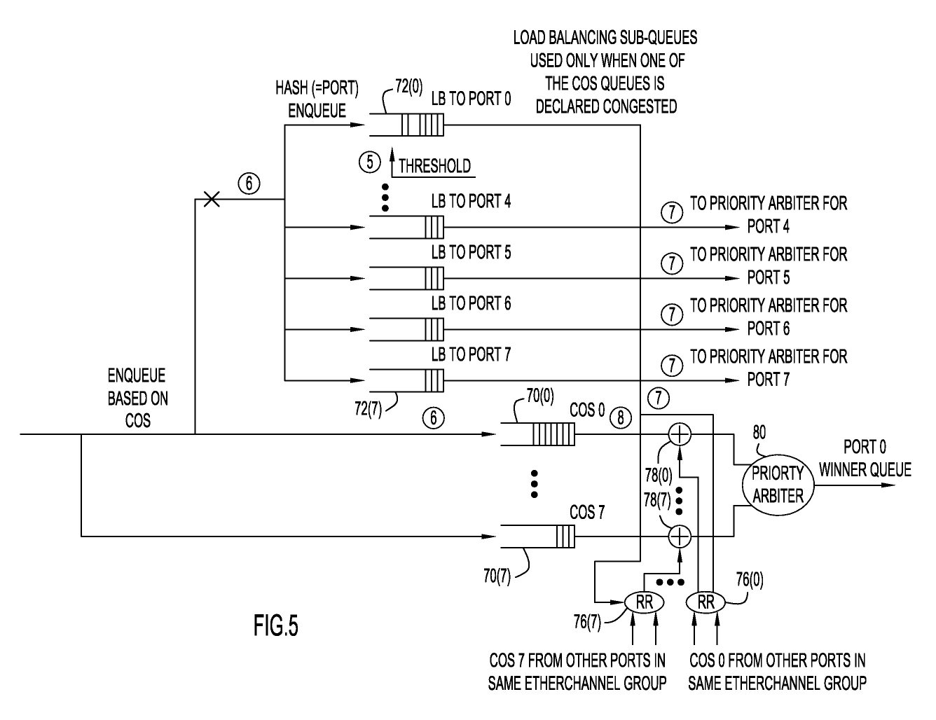

There is also a priority arbiter logic circuit 80 that is configured to schedule which of a plurality of regular queues is serviced based on a software configuration. Multiple COS queues are described hereinafter in connection with FIGS. 4 and 5. The priority arbiter 80, together with the read logic circuit 62, allows a packet to be read out of packet memory 56 and sent as output via the output circuit 64. The priority arbiter 80 may be implemented separately or as part of the read logic circuit 62 as this block has the ultimate authority to control from which queue a packet will be read. In one implementation, the priority arbiter 80 comprises digital logic circuitry and a plurality of counters to keep track of queue selections.

Request from the queues (when multiple regular queues are employed) are sent to the priority arbiter 80. The priority arbiter 80 generates a queue number grant and sends it back to the queuing subsystem 58. The RR arbiter 76 generates a packet pointer for a packet (from the selected sub-queue corresponding to one of the ports of the EtherChannel group for the same COS) and sends the packet pointer information to the read logic circuit 62, which retrieves the appropriate packet from the packet memory 56 for output via the output circuit 64. The read logic circuit 62 also feeds back information concerning the output packet to the priority arbiter 80 in order to update its own internal counters.

The load balancing sub-queues can be activated by a combination of register configurations and congestion indication by the queue level monitoring logic. For example, there are configuration registers (not shown) that can be allocated to enable/disable the LB sub-queues, and to specify the number of ports in an EtherChannel group and the hashing-to-port mapping.

The general sequence of events for operation of the priority arbiter 80 and related logic circuits shown in FIG. 2 is as follows. Initially, packets in a flow are forwarded to an output port based on the input logic port decision resulting from the computations of the hashing circuit 52. The queue level monitor 60, in real-time, monitors the level of the individual output queues within an EtherChannel group. If any output queue grows beyond a certain threshold, the overburdened (congested) queue is split into a number of logical sub-queues on the fly. As explained above, the number of sub-queues created is equal to the number of physical ports in the EtherChannel group and each created sub-queue is associated with a corresponding physical output port.

The flows that were being enqueued to the congested queue are separated into the sub-queues using a hashing scheme (e.g., the 8-bit to 3-bit hashing scheme) that provides in order packet delivery within a flow and also that any particular flow will be forwarded to the same sub-queue. The 3-bit hash is again collapsed into values that ranges from 0 to N−1 which in turn indexes to one of the sub-queues. The 8-bit to 3-bit rehashing scheme minimizes clumping to one single queue. All the sub-queues corresponding to the ports of the EtherChannel group forwarding flows to a particular physical port are then serviced in a round robin (RR), weighted round robin (WRR) or deficit WRR (DWRR) fashion. This effectively relieves the congestion and rebalances the flows to the other links within the EtherChannel group. Once the level of the original (problem) queue falls below a certain threshold (indicating that the links are no longer overutilized), the logical sub-queues are collapsed into a single queue. Creation and collapsing of the queues are initiated by the level of fullness of any queue. The sub-queues can be reused again for other problem queues in the same manner.

The sub-queuing techniques described herein are applicable when there is one or a plurality of classes of services of packet flows handled by the switch. FIG. 2 shows a single regular queue for the case where there is a single class of service. If the switch were to handle packet flows for a plurality of classes of service, then there would be memory locations or registers allocated for a regular queue for each of the classes of service.

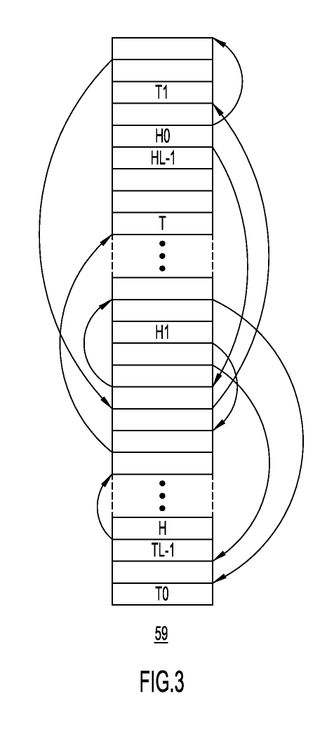

FIG. 3 shows an arrangement of the link list memory 59 for the regular queue 70 and sub-queues. The arrows show the linking of the packet pointers in a queue. The start point for a queue (or sub-queue) is the head (H) and from the head the arrows can be traversed to read all the packet pointers until the tail (T) is reached, which is the last packet pointer for a queue (or sub-queue). This structure is used to honor in order packet delivery (the order the packets came in). The link list H to L is the regular link list while the link list H# to T# is for the sub-queues numbered 0-(L−1) in the example of FIG. 3. This shows that the same resource (memory structure) that is used to store the order of packet delivery is also used for the sub-queues, thereby avoiding any overhead to accommodate the sub-queues. Packets in a queue are linked together so that they can be sent in the order they are received. When subsequent packets arrive for a queue, they are linked to the previous packets. When transmitting packets, the read logic follows the links to send the packets out in order. The link list memory 59 holds these packet links as shown in FIG. 3. The arrows point to the next packet in that queue. Since the packet pointers are unique, there can be link lists for different queues in the same memory structure. FIG. 3 shows a single memory containing multiple queue link lists (each corresponding to different queues and/or sub-queues).

Creation of Sub-Queues

Reference is now made to FIG. 4, with continued reference to FIG. 2. In the example shown in FIG. 4, there are a plurality of classes of service that the switch handles, indicated as COS 0 through COS 7. There is a regular queue for each COS indicated at reference numerals 70(0)-70(7), respectively. There are 8 sub-queues in this example shown at reference numerals 72(0)-72(7), corresponding to the 8 output ports of an EtherChannel group.

Packets are enqueued to one of the COS regular queues 70(0) to 70(7) based on their COS. For example, packets in COS 0 are all enqueued to queue 70(0), packets in COS 1 are enqueued to queue 70(1), and so on. The priority arbiter 80 selects packets from the plurality of COS regular queues 70(0)-70(7) after adders shown at 78(0)-78(7) associated with each regular queue 70(0)-70(7) and sub-queues (of the same COS) from other ports that are in the same EtherChannel group. There is a RR arbiter for each COS, e.g., RR arbiter 76(0), . . . , 76(7) in this example. The RR arbiters 76(0)-76(7) select packets from the plurality of sub-queues from other ports (for a corresponding COS) according to a round robin scheme. The outputs of the respective RR arbiters 76(0)-76(7) are coupled to a corresponding one of the adders 78(0)-78(7) associated with the regular queues 70(0)-70(7), respectively, depending on which of the COS regular queues is selected for sub-queuing.

In this example, the states of the 8 regular queues 70(0)-70(7) are sent to the priority arbiter 80. The priority arbiter 80 then checks the software configuration parameters (which are tied to the classes of services served by the device) to determine which is the next COS queue to be serviced. A higher priority COS will be serviced more often than a lower priority COS. The priority arbiter 80 then sends an indication of the queue to be serviced next, referred to as the queue number grant in FIG. 2, to the queuing subsystem 58. The packet pointer information for the packet at the head of the selected queue is sent, via the appropriate one of the adders 78(0)-78(7), to the read logic 62 that reads the packet from the packet memory 56 and sends it out via the output circuit 64. The queuing subsystem 58 then updates the head of the selected queue with the next packet pointer by traversing the selected queue link list.

Any of the COS regular queues 70(0)-70(7) (most likely the lowest priority queue) can accumulate packets (grow) beyond a configured predetermined threshold. A sequence of events or operations labeled “1“−”4” in FIG. 4 illustrate creation of the sub-queues. In the example of FIG. 4, COS 70(0) has accumulated packets greater than the threshold. This is detected at “1” by the queue level monitor 60.

At “2”, the COS queue 70(0) is declared to be congested and new packets are no longer enqueued into COS queue 70(0) only. Instead, they are queued into the LB sub-queues 72(0)-72(7). Packets to other COS queues continue to be sent to their respective COS queues. An 8- to 3-bit hashing number and port map is used to select which of the sub-queues 72(0)-72(7) a packet is enqueued. The LB sub-queues are not de-queued yet. A plurality of COS sub-queues are effectively created on fly and, as explained above, the number of sub-queues created depends on the number of ports in the EtherChannel group under evaluation. In this example, there are 8 LB sub-queues because there are 8 physical ports in the EtherChannel group. The sub-queue number specifies to which output port the packet will eventually be forwarded.

At “3”, COS queue 70(0) is continued to be de-queued via the priority arbiter grant operation 80 until COS queue 70(0) is empty.

At “4”, after the COS 70(0) queue is empty, packets from the sub-queues 72(0)-72(7) are de-queued by the RR arbiter 76(0) of the respective ports 0-7 in the EtherChannel group. Since the COS queue 70(0) is completely de-queued before the sub-queues are de-queued, packets within a given flow are ensured to always be de-queued in order.

If the 3-bit hash function puts all the flows into one of the sub-queues (that is assigned to one, e.g., the same, port), then the queuing and de-queuing operations will operate as if there are no sub-queues.

Sub-Queue Collapsing

FIG. 5 illustrates the sequence of operations or events labeled “5”-“8” associated with collapsing of the sub-queues. Once all the LB sub-queues of an enabled EtherChannel group reduces to a configured threshold, an indication is sent by the queue level monitor 60, the sub-queues are marked as being in an “in freeing” state and packets are not enqueued into the sub-queues. At “5”, this is triggered by a signal from the queue level monitor 60. At “6”, the original COS port queue is enqueued.

At “7”, packets are continued to be de-queued from the sub-queues 72(0)-72(7) until all of sub-queues 72(0)-72(7) are empty. At “8”, after all the sub-queues 72(0)-72(7) are empty, the original COS queue is de-queued. This ensures that packets within a flow are always de-queued in proper order.

At this point, the sub-queues 72(0)-72(7) are declared to be free and available for use by any COS queue that is determined to be congested.

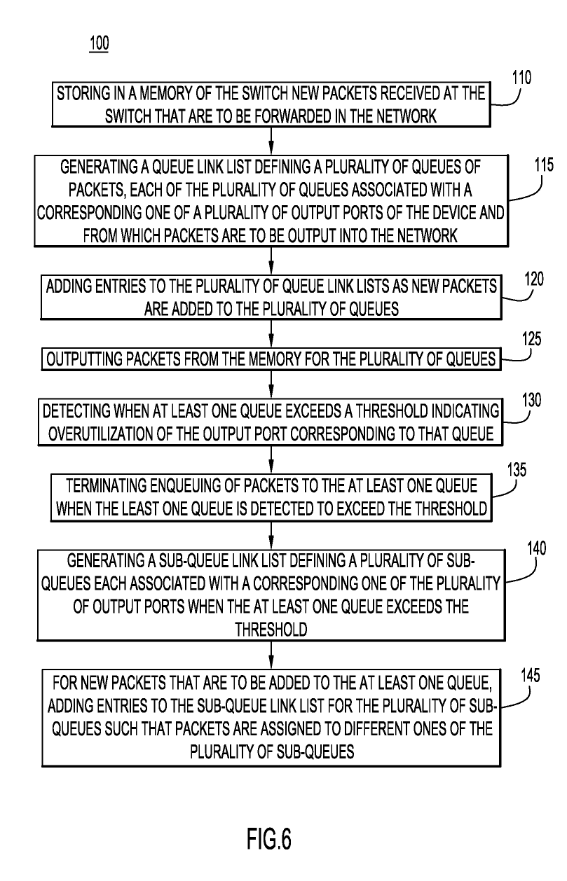

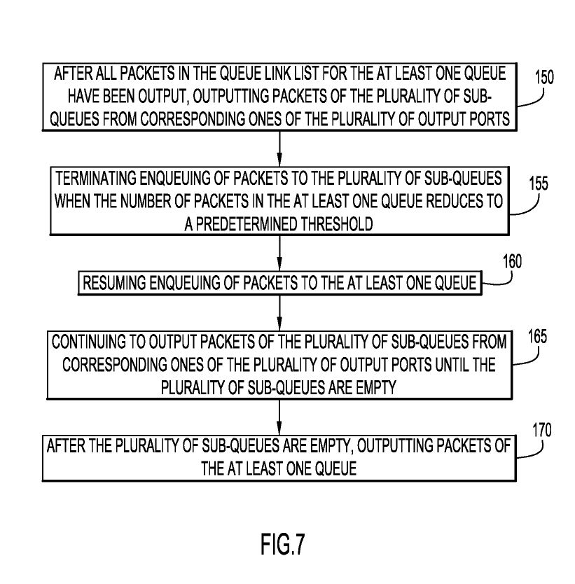

Reference is now made to FIGS. 6 and 7 for a description of a flow chart for a process 100 representing the operations depicted by FIGS. 4 and 5 in a switch, router or other device to use sub-queues for load balancing among output ports in an EtherChannel group. The description of FIGS. 6 and 7 also involves reference to the block diagram of FIG. 2. At 110, the switch stores in memory, e.g., memory arrays 56, new packets that it receives and which are to be forwarded from the switch to other switches or devices in a network. At 115, the switch generates a plurality of queues (represented by a plurality of queue link lists), each of the plurality of queues being associated with a corresponding one of a plurality of output ports of the switch and from which packets are to be output to the network. As explained above in connection with FIGS. 4 and 5, the sub-queuing techniques are applicable when there is a single class of service queue or multiple classes of service queues.

At 120, the switch adds entries to the plurality of queue link lists as new packets are added to the plurality of queues based on the hashing by the hashing circuit 52. When multiple classes of service are supported by the switch, the adding operation 120 involves adding entries to corresponding ones of the plurality of queue link lists for new packets based on the classes of service of the new packets.

At 125, the read logic circuit 62 reads packets from the memory arrays 56 for output via output circuit 64 for the plurality of queues according to entries in the plurality of queue link lists stored in the memory 59.

At 130, the queue level monitor circuit 60 detects when the number of packets (or bytes) enqueued in at least one queue exceeds a threshold indicating overutilization of the output port corresponding to that queue. The queue level monitor circuit 60 may make this determination based on the number of packets in the at least one queue exceeding a threshold or the number of bytes in the queue exceeding a threshold (to account for packets of a variety of payload sizes such that some packets may comprise more bytes than other packets). The detecting operation at 130 may detect when any one of the plurality of queues exceeds a threshold. When this occurs, at 135, packets intended for that queue are no longer enqueued to it and adding of entries to the queue link list for the at least one queue is terminated.

At 140, when the at least one queue exceeds the threshold, a sub-queue link list is generated and stored in memory 59. The sub-queue link list defines a plurality of sub-queues 72(0)-72(L−1) each associated with a corresponding one of the plurality of output ports in an EtherChannel group. Moreover, the plurality of sub-queues is generated when any one of the plurality of queues is determined to exceed the threshold. At 145, for new packets that are to be enqueued to the at least one queue, entries are added to the sub-queue link list for the plurality of sub-queues 72(0)-72(L−1) to enqueue packets to the plurality of sub-queues such that packets are assigned to different ones of the plurality of sub-queues when the at least one queue exceeds a threshold. For example, the assignment of packets to sub-queues is made by the 8-bit to 3-bit hashing circuit 74 that performs a hashing computation that is configured to ensure that packets for a given flow of packets are assigned to the same sub-queue to maintain in-order output of packets within a given flow.

While operation 145 is performed for newly received packets for the at least one queue, packets are output from the memory 56 that were in the at least one queue. Eventually, the at least one queue will become empty.

At 150, after all packets in the queue link list for the at least one queue have been output from the memory 59, packets are output for the plurality of sub-queues 72(0)-72(L−1), via read logic circuit 62 and output circuit 64, from the memory 56 according to the sub-queue link list in memory 59, and ultimately from corresponding ones of the plurality of output ports. Packets of the plurality of sub-queues may be output in a RR, WRR, or DRR manner.

At 155, when traffic intended for the at least one queue (that is currently using the plurality of sub-queues 72(0)-72(L−1)) reduces to a predetermined threshold, then enqueuing of entries to the sub-queue link list for the plurality of sub-queues is terminated. The queue level monitor circuit 60 generates a control signal to terminate enqueuing of packets to the plurality of sub-queues when the number of packets in the plurality of sub-queues reduces to a predetermined threshold. Packets can be enqueued to the original queue link list for the at least one queue. Thus, at 160, adding of entries to the queue link list for new packets to be added to the at least one queue is resumed. At 165, packets are continued to be output from the plurality of sub-queues, and at 170, after all packets in the sub-queue link list for the plurality of queues have been output from memory 56, via read logic circuit 62 and output circuit 64, packets are output from the memory 56 for at least one queue according to the queue link list for that queue. Also, after the plurality of sub-queues are empty, they can be freed up for use for another congested output port.

In summary, operations 130-145 are associated with creation of the plurality of sub-queues, operation 150 involves de-queuing of the plurality of sub-queues and operations 155-170 are associated with the collapsing of the plurality of sub-queues.

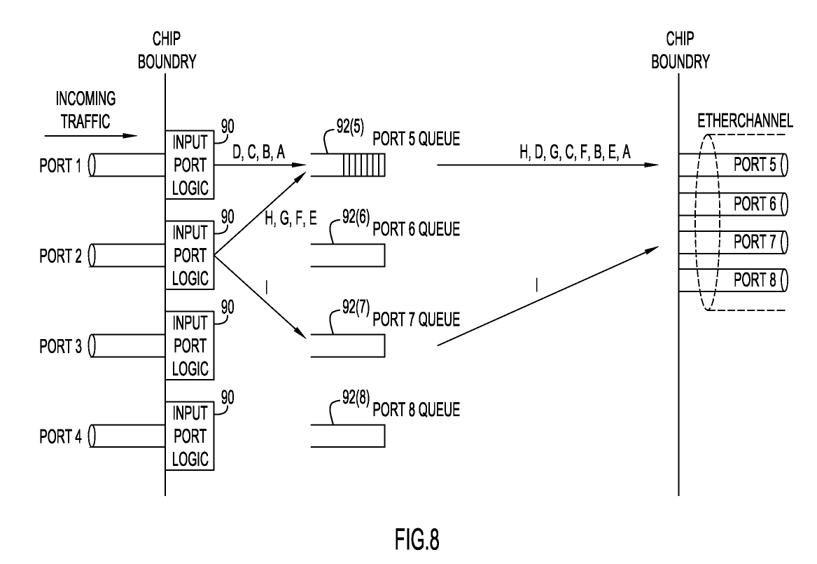

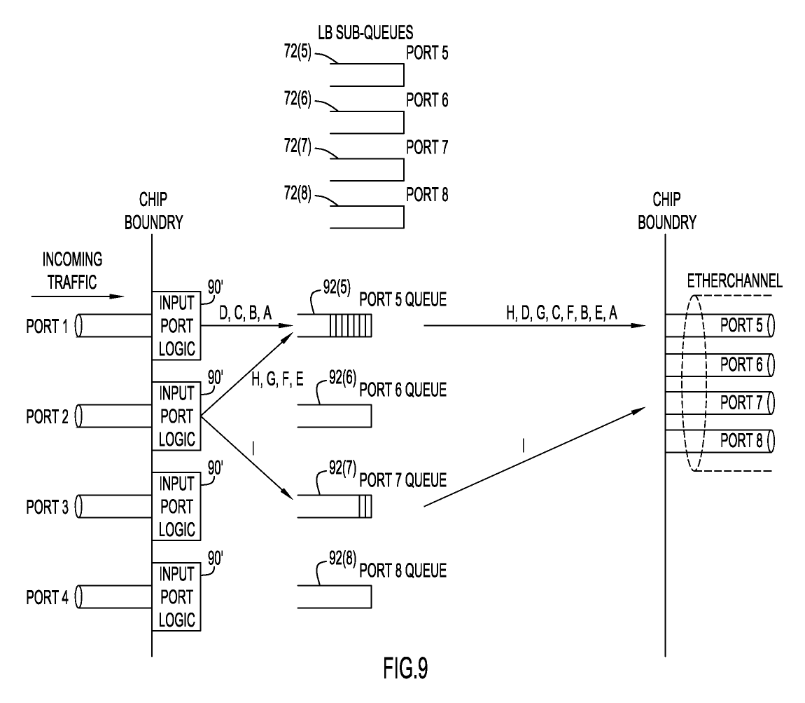

Reference is now made to FIG. 8 for a description of a scenario that would benefit from the load balancing techniques described herein. FIG. 9 is thereafter described that illustrates how the sub-queuing techniques described herein alleviate the load balancing problem depicted by the example shown in FIG. 8. The “chip boundary” indicated in FIGS. 8 and 9 refers to an application specific integrated circuit (ASIC) comprising the memory arrays 56 depicted in FIG. 2.

In this example, a switch has 8 ports labeled Port 1 to Port 8. Port 5 to Port 8 are configured to be an EtherChannel group. Port 1 is receiving flows A, B, C, D and Port 2 is receiving flows E, F, G, H, I while all the other ports are inactive. These flows are all associated with the same COS for purposes of this example. There is input port logic 90 associated with Ports 1-4, respectively, and queues 92(5)-92(8) associated with Ports 5-8, respectively. The input port logic 90 shown in FIG. 8 uses a hashing scheme and static EtherChannel port map. As a result, all the flows are enqueued to queue 92(5) for physical Port 5 queue except for flow I which is enqueued to the queue 92(7) for Port 7. Most of the flows are subsequently forwarded from one physical Port 5 while flow I is forwarded from Port 7 as shown in the FIG. 8. This scenario results in suboptimal use of the EtherChannel as most of the flows are forwarded to a single physical port. Additionally, this creates congestion that may lead to frames being dropped and increased latency.

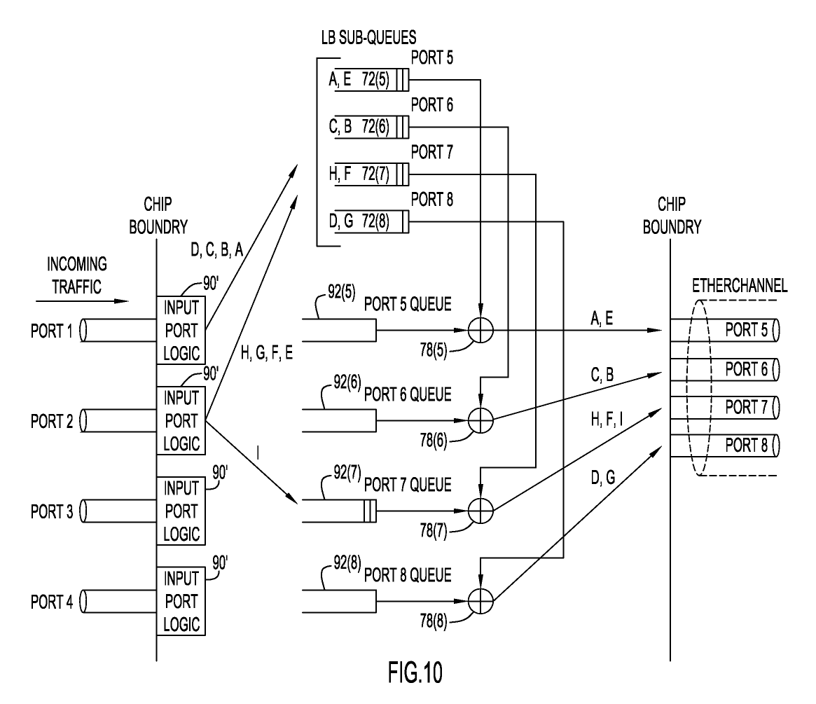

The same example of FIG. 8, but using dynamically created LB sub-queues, is illustrated in FIGS. 9 and 10. Again, all of the packet flows shown in FIGS. 9 and 10 are associated with the same COS. The input port logic 90′ uses the dynamic load balancing techniques described herein. When the number of bytes accumulated in queue 92(5) of Port 5 exceeds a threshold, this indicates that physical Port 5 is overutilized or congested. In response, LB sub-queues 72(5)-72(8) are dynamically created as shown in FIG. 9, where LB sub-queue 72(5) is assigned to Port 5, LB sub-queue 72(6) is assigned to Port 6, LB sub-queue 72(7) is assigned to Port 7 and LB sub-queue 72(8) is assigned to Port 8.

In FIG. 10, the flows are segregated and redirected to the LB sub-queues 72(5)-72(8) using a hash function and port map as described above in connection with FIGS. 3-7. For example, flows A and E are directed to LB sub-queue 72(5) that is associated with Port 5, flows C and B are directed to sub-queue 72(6) that is associated with Port 6, flows H and F are directed to sub-queue 72(7) that is associated with Port 7 and flows D and G are directed to sub-queue 72(8) that is associated with Port 8. The segregated flows are then forwarded to their corresponding physical ports by way of adders 78(5)-78(8), respectively. Each physical port is now optimally utilized, thereby resulting in increased throughput, better latency and reduced dropped frames due to buffer overflow.

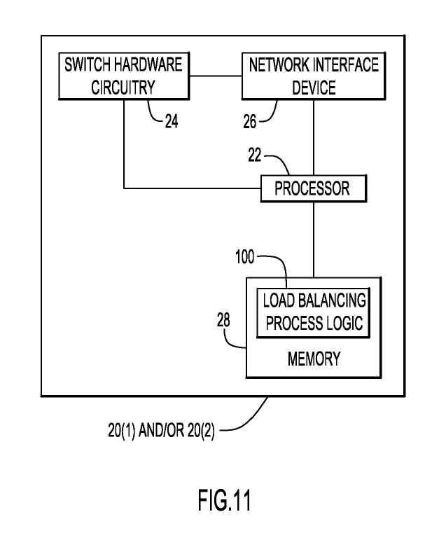

Turning now to FIG. 11, a block diagram is shown for a switch, router or other device configured to perform the sub-queuing techniques described herein. In this version of the device block diagram, the device performs the sub-queuing techniques uses software executed by a processor in the switch. To this end, the switch comprises a processor 22, switch hardware circuitry 24, a network interface device 26 and memory 28. The switch hardware circuitry 24 is, in some examples, implemented by digital logic gates and related circuitry in one or more ASICs, and is configured to route packets through a network using any one of a variety of networking protocols. The network interface device 26 sends packets from the switch to the network and receives packets from the network that are sent to the switch. The processor 22 is, for example, a microprocessor, microcontroller, digital signal processor or other similar data processor configured for embedded applications in a switch.

The memory 28 may comprise read only memory (ROM), random access memory (RAM), magnetic disk storage media devices, optical storage media devices, flash memory devices, electrical, optical, or other physical/tangible memory storage devices. The memory 28 stores executable software instructions for packet sub-queuing process logic 100 as well as the link lists for the regular queues and for the sub-queues as well as the packets to be output. Thus, the memory 28 may comprise one or more computer readable storage media encoded with software comprising computer executable instructions and when the software is executed operable to perform the operations described in connection with FIGS. 6 and 7 for the process logic 100.

The sub-queuing techniques described herein provide a dynamic scheme to optimally utilize the physical links within an EtherChannel. These techniques are used when congestion is detected on a physical port and is applied only for the problem port. Furthermore, these techniques improve over the inefficient input static port assignment in an EtherChannel, resulting in optimal link utilization, improved latency and reduced congestion and dropped packets.

The above description is intended by way of example only.

What is claimed is:

1. A method comprising:
at a device configured to forward packets in a network, generating a plurality of queues each associated with a corresponding one of a plurality of output ports of the device and from which packets are to be output from the device into the network;
detecting when a number of packets in at least one queue exceeds a threshold;
when the number of packets in the at least one queue exceeds the threshold, for new packets that are to be enqueued to the at least one queue, enqueuing the packets to a plurality of sub-queues such that packets are assigned to different ones of the plurality of sub-queues, wherein each of the plurality of sub-queues is associated with a corresponding one of the plurality of output ports; and
outputting packets of the plurality of sub-queues from corresponding ones of the plurality of output ports.

2. The method of claim 1, wherein outputting comprises outputting packets of the plurality of sub-queues from corresponding ones of the plurality of output ports after all packets in the at least one queue have been output.

3. The method of claim 1, and further comprising:
terminating enqueuing packets to the plurality of sub-queues when the number of packets in the at least one queue reduces to a predetermined threshold;
enqueuing packets to the at least one queue;
continuing to output packets of the plurality of sub-queues from corresponding ones of the plurality of output ports until the plurality of sub-queues are empty; and
after the plurality of sub-queues are empty, outputting packets of the at least one queue.

4. The method of claim 1, wherein generating the plurality of sub-queues comprises generating the plurality of sub-queues such that each sub-queue corresponds to one of the plurality of output ports that are in an EtherChannel group.

5. The method of claim 1, wherein detecting comprises detecting when any one of the plurality of queues exceeds a threshold, and wherein generating the plurality of sub-queues is performed when any one of the plurality of queues is determined to exceed the threshold.

6. The method of claim 1, wherein enqueuing packets to the plurality of sub-queues comprises performing a hashing computation on packets for the at least one queue in order to enqueue the packets for the at least one queue to the plurality of sub-queues so as to ensure in-order packet delivery of packets within a flow of packets.

7. The method of claim 1, wherein outputting comprises outputting packets of the plurality of sub-queues in a round robin manner.

8. An apparatus comprising:
a plurality of input ports configured to receive packets from a network and a plurality of output ports configured to output packets to the network;
memory configured to store packets to be forwarded via the plurality of output ports to the network; and
a processor configured to:
generate a plurality of queues each associated with a corresponding one of the plurality of output ports and from which packets are to be output to the network;
detect when a number of packets in at least one queue exceeds a threshold;
when the number of packets in the at least one queue exceeds the threshold, for new packets that are to be enqueued to the at least one queue, enqueue packets to a plurality of sub-queues such that packets are assigned to different ones of the plurality of sub-queues, wherein each of the plurality of sub-queues is associated with a corresponding one of the plurality of output ports; and
output packets of the plurality of sub-queues from corresponding ones of the plurality of output ports.

9. The apparatus of claim 8, wherein the processor is configured to output packets of the plurality of sub-queues from corresponding ones of the plurality of output ports after all packets in the at least one queue have been output.

10. The apparatus of claim 8, wherein the processor is further configured to:
terminate enqueuing packets to the plurality of sub-queues when the number of packets in the at least one queue reduces to a predetermined threshold;
enqueue packets to the at least one queue;
continue to output packets of the plurality of sub-queues from corresponding ones of the plurality of output ports until the plurality of sub-queues are empty; and
after the plurality of sub-queues are empty, output packets of the at least one queue.

11. The apparatus of claim 8, wherein the plurality of output ports are part of an EtherChannel group.

12. The apparatus of claim 8, wherein the processor is configured to detect when any one of the plurality of queues exceeds a threshold, and to generate the plurality of sub-queues when any one of the plurality of queues is determined to exceed the threshold.

13. The apparatus of claim 8, wherein the processor is configured to enqueue packets to the plurality of sub-queues based on a hashing computation performed on packets for the at least one queue in order to enqueue the packets for the at least one queue into the plurality of sub-queues so as to ensure in-order packet delivery of packets within a flow of packets

14. One or more computer readable storage media encoded with software comprising computer executable instructions and when the software is executed operable to:
generate a plurality of queues each associated with a corresponding one of a plurality of output ports from which packets are to be output to a network;
detect when a number of packets in at least one queue exceeds a threshold;
when the number of packets in the at least one queue exceeds the threshold, for new packets that are to be enqueued to the at least one queue, enqueue packets to a plurality of sub-queues such that packets are assigned to different ones of the plurality of sub-queues, wherein each of the plurality of sub-queues is associated with a corresponding one of the plurality of output ports; and
output packets of the plurality of sub-queues from corresponding ones of the plurality of output ports.

15. The computer readable storage media of claim 14, wherein the instructions that are operable to output packets comprise instructions operable to output packets of the plurality of sub-queues from corresponding ones of the plurality of output ports after all packets in the at least one queue have been output.

16. The computer readable storage media of claim 14, and further comprising instructions operable to:
terminate enqueuing of packets to the plurality of sub-queues when the number of packets in the at least one queue reduces to a predetermined threshold;
enqueue packets to the at least one queue;
continue to output packets of the plurality of sub-queues from corresponding ones of the plurality of output ports until the plurality of sub-queues are empty; and
after the plurality of sub-queues are empty, output packets of the at least one queue.

17. The computer readable storage media of claim 14, wherein the instructions that are operable to enqueue packets to the plurality of sub-queues comprises instructions operable to perform a hashing computation on packets for the at least one queue in order to enqueue the packets for the at least one queue into the plurality of sub-queues so as to ensure in-order packet delivery of packets within a flow of packets.

18. An apparatus comprising:
a plurality of input ports configured to receive packets from a network and a plurality of output ports configured to output packets to the network;
a memory array configured to store packets to be forwarded via the plurality of output ports to the network; and
a link list memory configured to store a plurality of link lists for a plurality of queues each associated with a corresponding one of the plurality of output ports and a plurality of sub-queues each associated with a corresponding one of the output ports;
a queue level monitor circuit configured to detect when a number of packets in at least one queue exceeds a threshold;
a hashing circuit configured to enqueue packets for the at least one queue to the plurality of sub-queues such that packets are assigned to different ones of the plurality of sub-queues when the at least one queue exceeds the threshold; and
an output circuit configured to output packets of the plurality of sub-queues from corresponding ones of the plurality of output ports.

19. The apparatus of claim 18, wherein the hashing circuit is configured to perform a hashing computation of packets for the at least one queue in order to enqueue the packets for the at least one queue to the plurality of sub-queues so as to ensure in-order delivery of packets within a flow of packets.

20. The apparatus of claim 19, wherein the queue level monitor is configured to generate a control signal to terminate enqueuing of packets to the plurality of sub-queues when the number of packets in the at least one queue reduces to a predetermined threshold so that packets are enqueued to the at least one queue, and the output circuit is configured to output packets of the plurality of sub-queues from corresponding ones of the plurality of output ports until the plurality of sub-queues are empty after which packets of the at least one queue are output.

21. The apparatus of claim 18, wherein the plurality of output ports are part of an EtherChannel group.
